(19) United States
(12) Patent Application Publication
(10) Pub. No.: US 2010/0009244 A1
(43) Pub. Date: Jan. 14, 2010

(54) ELECTRICITY STORAGE DEVICE AND VEHICLE INCLUDING THE SAME

(76) Inventor: Takashi Murata, Toyota-shi (JP)

Correspondence Address: KENYON & KENYON LLP, 1500 K STREET N.W., SUITE 700, WASHINGTON, DC, 20005, US

(21) Appl. No.: 12/302,561

(22) PCT Filed: Mar. 13, 2008
(86) PCT No.: PCT/IB2008/000582

§ 371 Date: Nov. 26, 2008

(30) Foreign Application Priority Data
Mar. 30, 2007 (JP) 2007-090155

(51) Int. Cl. H01M 2/12

(52) U.S. Cl. 429/53

(57) ABSTRACT

An electricity storage device has an electricity storage unit and a first container in which the electricity storage unit is contained, wherein, when an electricity storage unit abnormality occurs in which gas is produced in the electricity storage unit, the gas is discharged from the electricity storage unit into the first container. The electricity storage device is characterized by including: a first discharging channel for discharging the gas in the first container into the outside of a vehicle; and a second discharging channel for discharging the gas in the first container into a second container.

### BACKGROUND OF THE INVENTION

1. Field of the Invention

The present invention relates to an electricity storage device in which a container contains an electricity storage unit and a coolant for cooling the electricity storage unit.

2. Description of the Related Art

In recent years, electrically powered vehicles, such as electric vehicles and hybrid vehicles, have been actively developed. The demand for secondary batteries, for use as driving or auxiliary power sources for such electrically powered vehicles, that are excellent in performance, reliability and safety is developing.

In the field of electrically powered vehicles, driving or auxiliary power sources are required to have a high power density. As an example of such power sources, there is an electricity storage device that has a container that contains a battery pack, in which a plurality of cells are connected in series or in parallel, and a coolant for cooling the battery pack. The container includes a container body the upper side of which is open and a top lid that covers the upper opening of the container body. The top lid is fixed to the container body with fastening members.

Typically, each cell is provided with a gas-discharging valve for discharging gas that is produced by electrolysis of electrolytic solution due to overcharging, and excessive rise in internal pressure is prevented by discharging the gas through the gas-discharging valve.

Japanese Patent Application Publication No. 2005-71674(JP-A-2005-71674) describes a battery including resin cases each of which contains an electrode unit and is filled with an electrolytic solution. Each resin case is provided with a gas-discharging member for discharging gas, and a gas-discharging port formed in the gas-discharging member is fitted with a gas-discharging pipe for leading gas to the outside.

However, when a mere adaptation of the construction described in Japanese Patent Application Publication No. 2005-71674 (JP-A-2005-71674) is made, that is, when a gas-discharging pipe is connected to a container, the following problems arise.

First, when the internal pressure of the container rapidly rises because gas is produced in the cell(s), it is difficult to quickly reduce the internal pressure of the container only by discharging the gas through the gas-discharging pipe.

Second, it is required to increase the resistance to pressure of the container, and therefore, there is a possibility that the size and weight of electricity storage devices are increased.

### SUMMARY OF THE INVENTION

An object of the invention is to provide an electricity storage device capable of checking excessive rise in internal pressure due to gas produced by an electricity storage unit.

A first aspect of the invention is an electricity storage device including an electricity storage unit, a coolant for cooling the electricity storage unit and a first container in which the electricity storage unit is contained, wherein, when an electricity storage unit abnormality occurs in which gas is produced in the electricity storage unit, the gas is discharged from the electricity storage unit into the first container, the electricity storage device being characterized by including: a first discharging channel for discharging the gas in the first container into the outside of a vehicle; and a second discharging channel for discharging the gas in the first container into a second container.

The first and second discharging channels may be provided with a first and second gas-discharging valves, respectively.

The first gas-discharging valve may be allowed to discharge the gas before the second gas-discharging valve discharges the gas.

The value of the internal pressure of the first container at which the internal pressure allows the second gas-discharging valve to discharge the gas may be set lower than the value of the withstand pressure of the first container.

The value of the internal pressure of the first container at which the internal pressure allows the second gas-discharging valve to discharge the gas may be set higher than the value of the internal pressure at which the internal pressure allows the first gas-discharging valve to discharge the gas.

The first and second discharging channels may be configured so as to make it possible to discharge the gas through an upper wall portion of the first container.

When the electricity storage unit abnormality occurs, an ejection in which at least the gas and the coolant are contained may be discharged into the first discharging channel, and the first discharging channel may have a trap portion for trapping an ingredient of the ejection other than the gas.

The trap portion may include: a baffle plate disposed in the first discharging channel; and a storage portion in which the ingredient, other than the gas, that hits the baffle plate and drops is stored.

The ingredient other than the gas may include an electrolytic solution in the electricity storage unit.

The trap portion may include a plurality of the baffle plates and a plurality of the storage portions each disposed under an associated one of the plurality of baffle plates.

The gas that has flown into the second container through the second discharging channel may be discharged through the first discharging channel.

The second container may be an elastic container that is inflated by the gas that flows from the first container into the elastic container.

After the elastic container is inflated by the gas that flows into the elastic container, the elastic container may shrink as the gas is discharged through the first discharging channel.

The electricity storage unit may be an assembly of a plurality of electricity storage elements in which the plurality of electricity storage elements are connected in series or in parallel.

The above electricity storage device may be mounted on a vehicle.

With the invention, it is possible to check excessive rise in the internal pressure of the first container when a battery abnormality occurs.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is an exploded perspective view of an electricity storage device;

FIG. 2 is a sectional view of the electricity storage device;

FIG. 3 is a sectional view of a cylindrical battery;

FIG. 4 is a sectional view of a separation labyrinth chamber;

FIGS. 5A and 5B are diagrams for explaining operations of the electricity storage device that take place when a battery abnormality occurs, where FIG. 5A is a perspective view of the electricity storage device before the battery abnormality occurs, and FIG. 5B is a perspective view of the electricity storage device when the battery abnormality occurs; and

FIG. 6 is a sectional view of an electricity storage device of a second embodiment.

### DETAILED DESCRIPTION OF EMBODIMENTS

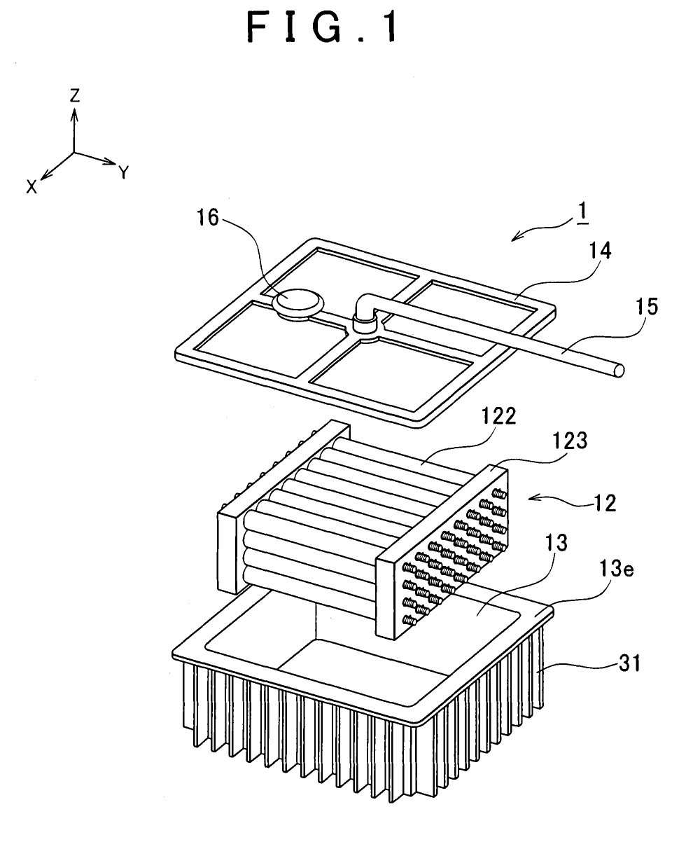

Embodiments of the invention will be described below with reference to FIGS. 1 to 6.

### First Embodiment

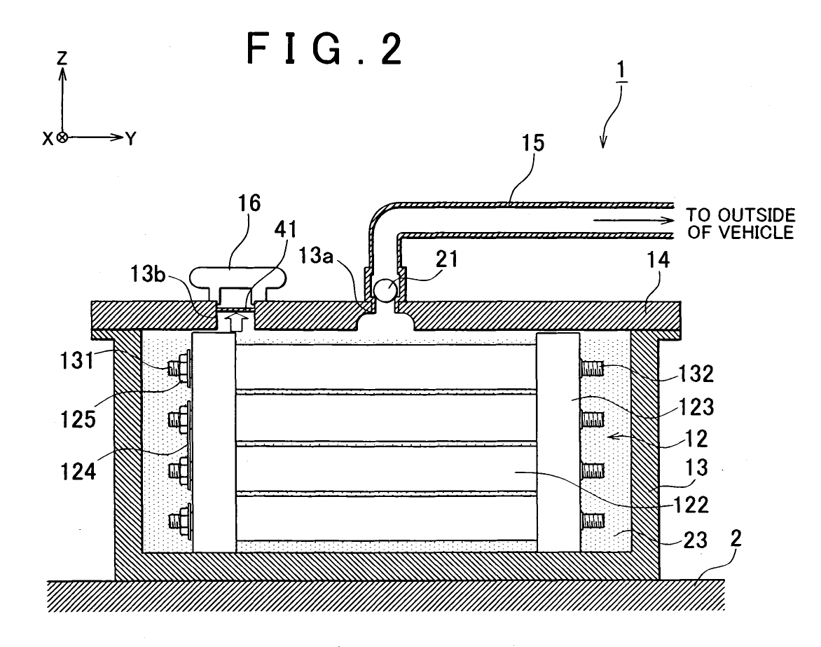

FIG. 1 is an exploded perspective view of an electricity storage device. FIG. 2 is a sectional view of the electricity storage device. In these figures, the electricity storage device 1 includes: a battery pack (electricity storage unit, electricity storage element assembly) 12; a battery case (first container) 13, which contains the battery pack 12 and a coolant 23; and a case cover (upper wall portion) 14, which serves as a top lid of the battery case 13. The electricity storage device is used as a driving power source or an auxiliary power source for a hybrid vehicle or an electric vehicle, for example.

Connected to the case cover 14, serving as a top lid of the battery case 13, are a gas-discharging pipe (first discharging channel) 15 and an elastic container (second container) 16, which are used to discharge gas to the outside of the battery case when a battery abnormality occurs.

When the battery abnormality occurs, the gas produced in the battery case 13 is discharged through the gas-discharging pipe 15, and, when the rise in the internal pressure of the battery case 13 cannot be controlled only by discharging the gas through the gas-discharging pipe 15, the gas is discharged through a second discharging channel into the elastic container 16, which functions as the second container.

The battery abnormality herein means a phenomenon in which an overcharge causes the electrolytic solution in cylindrical batteries 122 to be electrolyzed and gas is produced in the cylindrical batteries 122.

Accordingly, it is possible to set the resistance to pressure of the battery case 13 to a low level as compared to an electricity storage device that is not provided with the battery case 13, the case cover 14, and the elastic container 16, and it is therefore possible to reduce the size of the electricity storage device 1.

Next, a configuration of each part of the electricity storage device 1 will be described in detail.

(Battery Case 13)

The battery case 13 has a shape of an upwardly opening box, and a large number of radiator fins 31 are formed on the outer surface of the case. When a large number of radiator fins 31 are provided in this way, it is possible to increase the area of the surface that is in contact with the air, and promote heat dissipation from the battery pack 12.

Materials that can be used for the battery case 13 include metallic materials, such as a highly heat-conductive stainless steel.

A flange portion (not shown) is formed on the outer surface of the battery case 13. The electricity storage device 1 is mounted on a vehicle by fixing the flange portion to a floor panel 2 under a seat with fastening parts.

(Battery Pack 12)

The Battery pack 12 is a battery assembly in which a plurality of cylindrical batteries 122 are arranged in parallel with each other, and the plurality of cylindrical batteries 122 are held between a pair of battery holders 123. Electrode screw portions 131 and 132 of the cylindrical batteries 122 protrude from the pair of battery holders 123, and are electrically connected through bus bars 124. Fastening nuts 125 for fixing the bus bars 124 are screwed onto the electrode screw portions 131 and 132.

When a battery assembly in which the plurality of cylindrical batteries 122 are arranged in parallel with each other is used as a driving or auxiliary power source for a vehicle, the temperature increase caused by heat generation due to charge and discharge is large. Thus, when the battery pack 12 is cooled only by air cooling using cooling air flow, cooling can be insufficient. Thus, in the first embodiment, the battery pack 12 is cooled by immersing the battery pack 12 in the coolant 23 that has a heat conductivity higher than that of gas.

Substances that have high specific heat, high heat conductivity and high boiling point, that do not corrode the battery case 13 and the battery pack 12, and that are less prone to be thermally decomposed, oxidized by air, or electrolyzed, are suitable for the coolant 23. In addition, in order to prevent a short circuit between terminals, an electrically insulating liquid is desirable. For example, a fluorochemical inert liquid can be used. As the fluorochemical inert liquid, Fluorinert, Novec HFE (hydrofluoroether), and Novec 1230 (registered trademarks), made by 3M, can be used. Alternatively, a liquid (silicone oil, for example), other than the fluorochemical inert liquid, can also be used.

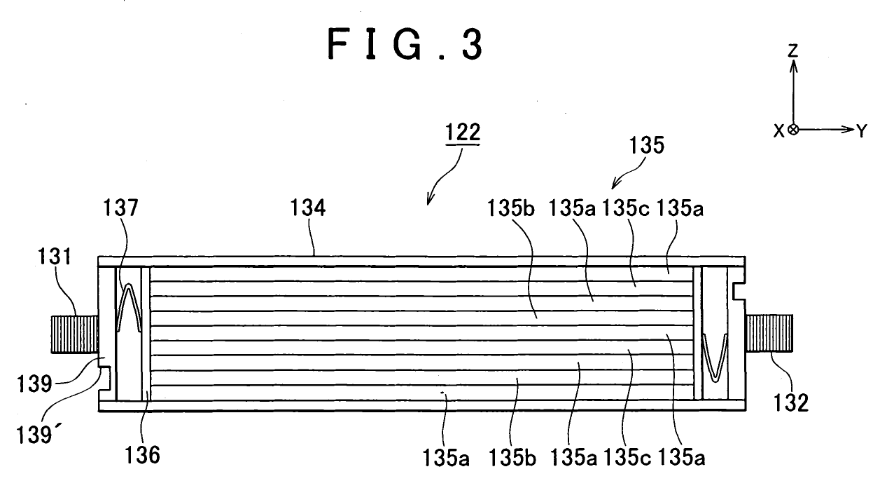

Next, a configuration of the cylindrical battery 122 will be described in detail with reference to FIG. 3. An electrode unit 135 is installed inside a cylindrical, battery casing 134.

The electrode unit 135 is formed by curling a belt-shaped positive electrode 135b on each side of which a positive electrode active material is applied, and a belt-shaped negative electrode 135c on each side of which a negative electrode active material is applied, with the positive and negative electrodes 135b and 135c sandwiched by separators 135a.

The battery casing 134 is filled with an electrolytic solution. Instead, the separators 135a may be impregnated with the electrolytic solution.

Examples of the positive electrode active material include LiCoO₂, LiNiO₂, LiFeO₂, LiCuO₂, LiMnO₂, LiMO₂ (M represents at least two transition elements selected from the group consisting of Co, Ni, Fe, Cu and Mn), and LiMn₂O₄, which are lithium-transient element compound oxides. The negative electrode active material is not particularly limited as long as the material is capable of electrochemically adsorbing and releasing lithium ion. Examples of the negative electrode active material include natural graphite, synthetic graphite, coke, carbonized organic materials, and metal chalcogenide.

Examples of lithium salt used as the solute in the electrolytic solution include LiClO₄, LiCF₃SO₃, LiPF₆, LiN(CF₃SO₂)₂, LiN(C₂F₅SO₂)₂, LiBF₄, LiSbF₆ and LiAsF₆. Examples of organic solvent include the mixture of cyclic carbonic ester, such as ethylene carbonate, propylene carbonate, vinylene carbonate and butylene carbonate, and chain carbonic ester, such as dimethyl carbonate, diethyl carbonate and methyl ethyl carbonate.

At each end of the electrode unit 135 with respect to the longitudinal direction (Y direction) of the electrode unit 135, a discoid current collector 136 is welded to the battery casing 134. Examples of material for the current collector 136 include an aluminum foil, a stainless foil, and a copper foil.

The current collectors 136 are electrically and mechanically connected to holding plates 139 through conductors 137, respectively, the holding plates 139 holding the positive and negative electrode screw portions 131 and 132.

In each of the holding plates 139, a breakage valve 139′ is formed at a position different from the position at which the positive or negative electrode screw portion 131 or 132 is placed. The breakage valves 139′ are formed by punching.

When the internal pressure of the battery casing 134 is increased to a pressure equal to or higher than a limit pressure (two atmospheres, for example) by the gas produced when the battery abnormality occurs, the breakage valve 139′ is broken, and the gas is discharged from the cylindrical battery 122 through the breakage valve 139′. Thus, it is possible to check the rise in the internal pressure of the battery casing 134.

(Case Cover 14)

The case cover 14 is fixed onto a cover fitting surface 13e of the battery case 13 with fastening bolts (not shown). In the state where the case cover 14 is fixed onto the battery case 13, the withstand pressure of the case cover 14 and the battery case 13 is set to five atmospheres.

In FIG. 2, a first gas-discharging port 13a is formed in a central portion of the case cover 14. The gas-discharging pipe 15 for discharging gas into the outside of the vehicle is connected to the first gas-discharging port 13a.

Because the gas produced when the battery abnormality occurs moves upward in the battery case 13, when the gas-discharging pipe 15 is connected to the case cover 14, it is possible to quickly discharge the gas.

A gas relief valve (first gas-discharging valve) 21 is provided at the connection portion between the gas-discharging pipe 15 and the first gas-discharging port 13a. When the internal pressure of the battery case 13 becomes equal to or higher than two atmospheres, the gas relief valve 21 is opened and allows gas to be discharged through the gas-discharging pipe 15.

On the other hand, when the internal pressure of the battery case 13 is lower than two atmospheres, the gas relief valve 21 remains closed. Thus, the battery case 13 is hermetically closed, and it is possible to prevent foreign matter from entering from the outside of the vehicle through the gas-discharging pipe 15 and getting mixed with the coolant 23.

A second gas-discharging port 13b is formed in a portion of the case cover 14 at the position different from that of the first gas-discharging port 13a. The inflatable elastic container 16 is connected to the second gas-discharging port 13b. The method in which the elastic container 16 is connected may be welding, or adhesion using adhesive agent, for example.

Material for the elastic container 16 may be nylon 66, for example. In order to provide the elastic container 16 with heat resistance, the surface of the nylon 66 may be coated with chloroprene rubber or silicone rubber, for example.

A container's breakage valve (second gas-discharging valve) 41 is formed in the second gas-discharging port 13b. When the internal pressure of the battery case 13 becomes equal to or higher than four atmospheres, the container's breakage valve 41 is broken and allows gas to be discharged into the elastic container 16 through the second gas-discharging port 13b. The container's breakage valve 41 is formed by subjecting the case cover 14 to a punching process.

By setting the pressure value (two atmospheres) at or above which the gas relief valve 21 is opened to discharge pressure, and the pressure value (four atmospheres) at or above which the container's breakage valve 41 is broken to discharge pressure, to values lower than the withstand pressure (five atmospheres) of the battery case 13, it is made possible to reduce the internal pressure of the battery case 13 before the internal pressure thereof reaches the withstand pressure.

Thus, it is possible to reduce the size and weight of the electricity storage device 1 by reducing the strength of the battery case 13 and the case cover 14.

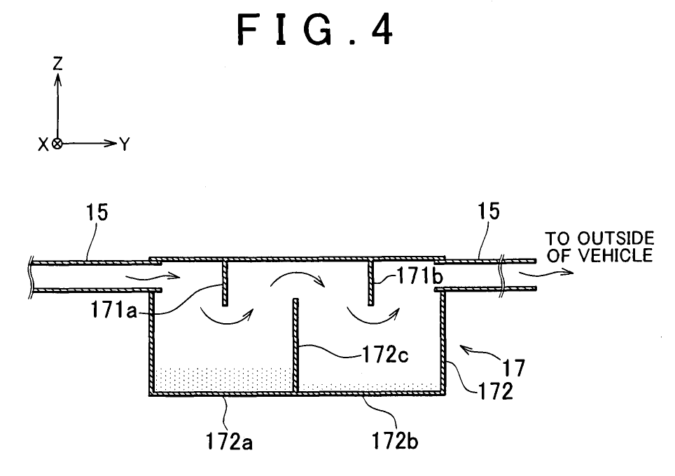

As shown in FIG. 4, the gas-discharging pipe 15 is provided with a separation labyrinth chamber 17 for trapping the coolant 23 that flows in from the battery case 13.

The separation labyrinth chamber 17 has a coolant storage portion 172. The coolant storage portion 172 is divided by a partition wall 172c into an upstream-side coolant storage portion 172a, which is located on the upstream side of the gas-discharging channel, and a downstream-side coolant storage portion 172b, which is located on the downstream side of the gas-discharging channel.

An upstream-side baffle plate 171a that extends in the gas-discharging channel formed by the gas-discharging pipe 15 is provided on the upper wall of the upstream-side coolant storage portion 172a. A downstream-side baffle plate 171b that extends in the gas-discharging channel formed by the gas-discharging pipe 15 is provided on the upper wall of the downstream-side coolant storage portion 172b.

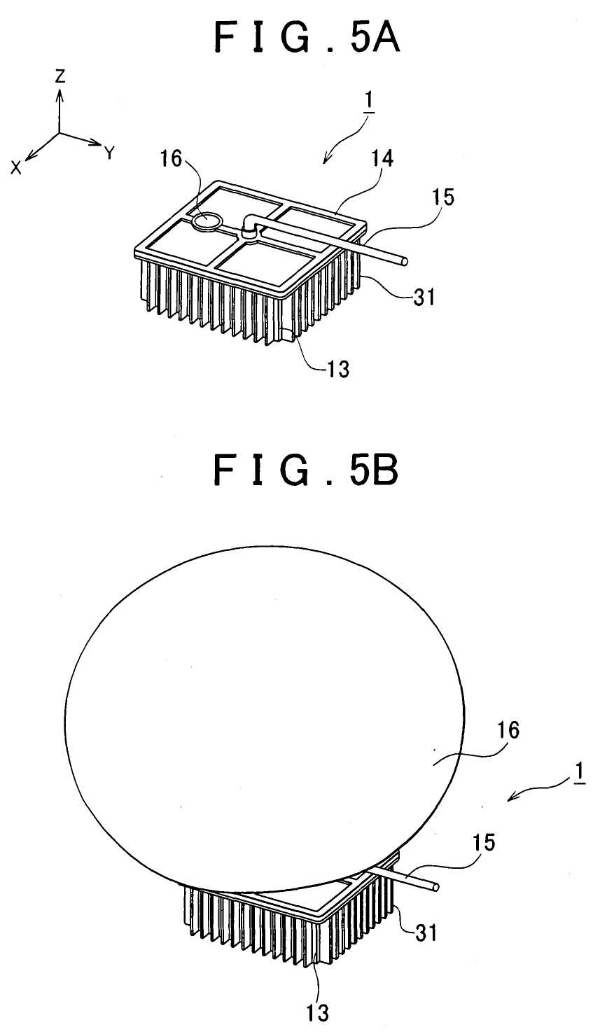

Next, referring to FIGS. 4 and 5, operations of the electricity storage device 1 that take place when the battery abnormality occurs will be described. FIGS. 5A and 5B are perspective views. More specifically, FIG. 5A is a perspective view of the electricity storage device 1 before the battery abnormality occurs, and FIG. 5B is a perspective view of the electricity storage device 1 when the battery abnormality occurs.

When the battery pack 12 is overcharged, the electrolytic solution in the cylindrical batteries 122 is electrolyzed and gas is produced, which causes the internal pressure of the battery casing 134 to increase. When the internal pressure of the battery casing 134 increases to two atmospheres, the battery's breakage valve 139′ is broken and gas is discharged into the coolant 23, which causes the internal pressure of the battery case 13 to immediately rise to two atmospheres.

When the internal pressure of the battery case 13 rises to two atmospheres, the gas relief valve 21 is opened, and gas is discharged into the gas-discharging pipe 15 through the first gas-discharging port 13a. The gas discharged into the gas-discharging pipe 15 is discharged outside the vehicle through the separation labyrinth chamber 17.

When this occurs, the gas discharged through the first gas-discharging port 13a can contain the coolant 23. The coolant 23 contained in the gas drops after the gas hits the upstream-side baffle plate 171a in the separation labyrinth chamber 17, and most of the coolant 23 is stored in the upstream-side coolant storage portion 172a. The rest is conveyed downstream with the gas in the course of dropping, drops after the gas hits the downstream-side baffle plate 171b, and is stored in the downstream-side storage portion 172b.

Thus, according to the first embodiment, the coolant 23 discharged into the gas-discharging pipe 15 is trapped in the separation labyrinth chamber 17, and it is possible to ensure the prevention of the coolant 23 from being discharged outside the vehicle.

When the battery abnormality occurs, the electrolytic solution ejected from the cylindrical batteries 122 can be discharged into the gas-discharging pipe 15 along with the coolant 23. The electrolytic solution is trapped in the separation labyrinth chamber 17 as in the case of the coolant 23, and it is therefore possible to ensure the prevention of the electrolytic solution from being discharged outside the vehicle.

A method is conceivable in which the coolant 23 is trapped using a sheet-type filter, which absorbs the coolant 23, provided in the gas-discharging pipe 15. However, there is a possibility that the filter is broken and the coolant 23 leaks outside the vehicle when gas pressure is high.

Thus, in the first embodiment, a structure is adopted in which the gas is caused to hit the baffle plates 171a and 171b so that the coolant 23 is trapped. In this way, it is possible to provide a highly reliable electricity storage device 1.

Returning to the description of the operations of the electricity storage device 1 that take place when the battery abnormality occurs, when the rise in the internal pressure cannot be controlled only by discharging the gas through the gas-discharging pipe 15, and the internal pressure of the battery case 13 rises from two atmospheres to four atmospheres, the container's breakage valve 41 is broken, and the gas in the battery case 13 flows into the elastic container 16 through the second gas-discharging port 13b.

As shown in FIG. 5B, the elastic container 16 is inflated and expanded as the gas flows into the elastic container 16, and the internal pressure of the battery case 13 gradually decreases. While the elastic container 16 is inflated, the discharge of gas through the gas-discharging pipe 15 still continues.

As described above, in the first embodiment, when the battery abnormality occurs, the gas is at first discharged through the gas-discharging pipe 15. When the rise in the internal pressure cannot be controlled only by discharging the gas through the gas-discharging pipe 15, the gas is discharged into the elastic container 16 to reduce the internal pressure of the battery case 13. In this way, it is possible to set the resistance to pressure of the battery case 13 lower than that of an electricity storage device 1 that is not provided with the elastic container 16. Thus, it is possible to reduce the size and weight of the electricity storage device 1.

When the internal pressure of the battery case 13 is reduced to a predetermined value that is higher than two atmospheres, the gas that has flown into the elastic container 16 returns into the battery case 13 through the second gas-discharging port 13b, and then discharged into the gas-discharging pipe 15 through the first gas-discharging port 13a. As the gas is discharged through the gas-discharging pipe 15, the elastic container 16 gradually shrinks.

Because the expanded elastic container 16 is caused to shrink by discharging the gas through the gas-discharging pipe 15 in this way, it is possible to avoid the unfavorable situation in which the elastic container 16 interferes with a surface of the seat when the electricity storage device 1 is removed. Thus, it is possible to make removing the electricity storage device 1 easy.

### Second Embodiment

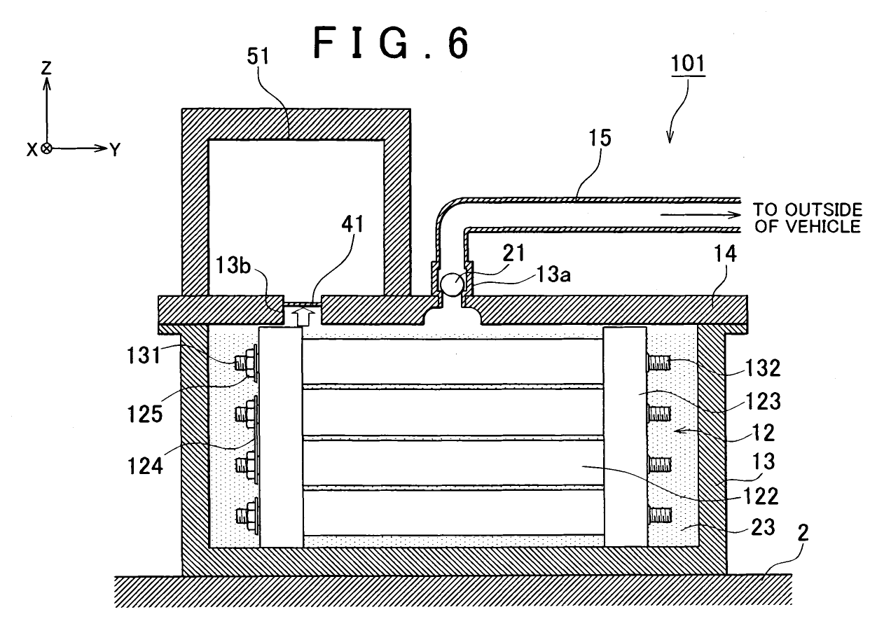

Next, referring to FIG. 6, an electricity storage device 101 of a second embodiment will be described. FIG. 6 is a sectional view of the electricity storage device 101, in which the same constituent element as that of the first embodiment is designated by the same reference numeral.

A pressure relief chamber (second container) 51 is fixed on the upper surface of the case cover 14. The pressure relief chamber 51 is connected to the battery case 13 through the container's breakage valve 41. Examples of material for the pressure relief chamber 51 include metallic material, such as stainless steel, which has a high thermal conductivity. The resistance to pressure of the pressure relief chamber 51 is set the same as that of the battery case 13.

The gas-discharging pipe 15 is provided with the separation labyrinth chamber 17 as in the case of the first embodiment.

Next, operations of the electricity storage device 101 that take place when the battery abnormality occurs will be described.

When the battery pack 12 is overcharged, the electrolytic solution in the cylindrical batteries 122 is electrolyzed and gas is produced, which causes the internal pressure of the battery casing 134 to increase. When the internal pressure of the battery casing 134 increases to two atmospheres, the breakage valve 139′ is broken and gas is discharged into the coolant 23, which causes the internal pressure of the battery case 13 to immediately rise to two atmospheres.

When the internal pressure of the battery case 13 rises to two atmospheres, the gas relief valve 21 is opened, and gas is discharged into the gas-discharging pipe 15 through the first gas-discharging port 13a. The gas discharged into the gas-discharging pipe 15 is discharged outside the vehicle through the separation labyrinth chamber 17. The coolant 23 that flows into the gas-discharging pipe 15 with the gas is trapped in the separation labyrinth chamber 17, and, as in the case of the first embodiment, there is no fear that the coolant 23 leaks outside the vehicle.

When the increase in the internal pressure cannot be controlled only by discharging the gas through the gas-discharging pipe 15, and the internal pressure of the battery case 13 further increases to four atmospheres, the container's breakage valve 41 is broken, and the gas in the battery case 13 is discharged into both the gas-discharging pipe 15 and the pressure relief chamber 51.

Thus, it is possible to set the resistance to pressure of the battery case 13 lower than that of an electricity storage device that is not provided with the pressure relief chamber 51. The gas that has flown into the pressure relief chamber 51 is discharged through the gas-discharging pipe 15 as the internal pressure of the battery case 13 decreases.

The electrical components, such as a battery ECU and a power switch, related to charge control of the battery pack 12 may be housed in the pressure relief chamber 51. With this configuration, it is possible to effectively use the space in the pressure relief chamber 51.

### Other Embodiments

The container's breakage valve 41 may be replaced by a valve that is the same as the gas relief valve 21. The gas relief valve 21 may be replaced by a valve that is the same as the container's breakage valve 41.

When the battery abnormality occurs, gas may be at first discharged into the elastic container 16 or the pressure relief chamber 51, and then discharged through the gas-discharging pipe 15.

A gas-discharging pipe (another gas-discharging pipe than the gas-discharging pipe 15) that communicates with the outside of the vehicle may be connected to the elastic container 16 or the pressure relief chamber 51 to directly discharge the gas in the elastic container 16 or the pressure relief chamber 51 into the outside of the vehicle.

The gas-discharging pipe 15 may be connected to a side wall of the battery case 13. The elastic container 16 or the pressure relief chamber 51 may be disposed adjacent to a side wall of the battery case 13. In this case, the gas relief valve 21 and/or the container's breakage valve 41 are provided at the side wall of the battery case 13.

In the present embodiment, a battery pack in which a plurality of cylindrical batteries are arranged in parallel is used. However, the invention can be applied to a rectangular battery (storage battery) and an electric double layer capacitor. An electric double layer capacitor is obtained by alternately stacking a plurality of positive and negative electrodes with a separator interposed between each pair of electrodes.

In this electric double layer capacitor, for example, an aluminum foil can be used as a current collector, activated carbon can be used as the positive electrode active material and the negative electrode active material, and a porous film made of polyethylene can be used as a separator.

The electricity storage device 1 may be disposed in the trunk room at the rear of the rear seat. In this case, a discharging port of the gas-discharging pipe 15 may be formed in the portion of the vehicle body of which position is adjacent to the trunk room in the lateral direction of the vehicle.

While the invention has been described with reference to what are considered to be preferred embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, less or only a single element, are also within the scope of the invention.

1. An electricity storage device comprising:
an electricity storage unit,
a coolant which cools the electricity storage unit; and
a first container in which the electricity storage unit and the coolant are contained, wherein, when an electricity storage unit abnormality occurs in which gas is produced in the electricity storage unit, the gas is discharged from the electricity storage unit into the first container,
the electricity storage device further comprising:
a first discharging channel for discharging the gas in the first container into an outside of a vehicle; and
a second discharging channel for discharging the gas in the first container into a second container.

2. The electricity storage device according to claim 1, further comprising:
a first gas-discharging valve provided on the first discharging channel; and
a second gas-discharging valve provided on the second discharging channel.

3. The electricity storage device according to claim 2, wherein
the first gas-discharging valve is allowed to discharge the gas before the second gas-discharging valve is allowed to discharge the gas.

4. The electricity storage device according to claim 3, wherein,
a value of an internal pressure of the first container at which the internal pressure allows the second gas-discharging valve to discharge the gas is lower than a value of a withstand pressure of the first container.

5. The electricity storage device according to claim 4, wherein,
the value of the internal pressure of the first container at which the internal pressure allows the second gas-discharging valve to discharge the gas is higher than a value of the internal pressure at which the internal pressure allows the first gas-discharging valve to discharge the gas.

6. The electricity storage device according to claim 1, wherein
the first and second discharging channels are provided to extend from an upper wall portion of the first container.

7. The electricity storage device according to claim 1, wherein:
when the electricity storage unit abnormality occurs, an ejection in which at least the gas and the coolant are contained is discharged into the first discharging channel; and
the first discharging channel has a trap portion for trapping the coolant.

8. The electricity storage device according to claim 7, wherein:
the ejection further contains an electrolytic solution; and
the first discharging channel has a trap portion for trapping an ingredient of the ejection other than the gas.

9. The electricity storage device according to claim 7, wherein
the trap portion includes: a baffle plate disposed in the first discharging channel; and a storage portion in which the ingredient, other than the gas, that hits the baffle plate and drops is stored.

10. The electricity storage device according to claim 9, wherein
the trap portion includes a plurality of the baffle plates and a plurality of the storage portions each disposed under an associated one of the plurality of baffle plates.

11. The electricity storage device according to claim 1, wherein
the gas that has flown into the second container through the second discharging channel is discharged through the first discharging channel.

12. The electricity storage device according to claim 1, wherein
the second container is an elastic container that is inflated by the gas that flows from the first container into the elastic container.

13. The electricity storage device according to claim 12, wherein,
after the elastic container is inflated by the gas that flows into the elastic container, the elastic container shrinks as the gas is discharged through the first discharging channel.

14. The electricity storage device according to claim 1, wherein
the electricity storage unit is an assembly of a plurality of electricity storage elements in which the plurality of electricity storage elements are connected in series or in parallel.

15. A vehicle on which the electricity storage device claim 1 is mounted.
